(19) United States
(12) Patent Application Publication
(10) Pub. No.: US 2006/0226107 A1
(43) Pub. Date: Oct. 12, 2006

(54) Self-adjusting slide block for telescopic crane jibs

(75) Inventors: Jan Brinkmann, Oldenburg (DE); Franz Paschke, Sande (DE); Rocco Staatz, Jever (DE)

Correspondence Address: BIRCH STEWART KOLASCH & BIRCH, PO BOX 747, FALLS CHURCH, VA, 22040-0747, US

(73) Assignee: Grove U.S. LLC

(21) Appl. No.: 11/349,940

(22) Filed: Feb. 9, 2006

(30) Foreign Application Priority Data
Feb. 10, 2005 (DE) 10 2005 006 118.4

(51) Int. Cl. B66C 23/04

(52) U.S. Cl. 212/350

(57) ABSTRACT

A slide block for a telescopic crane jib includes at least two mutually co-operating and relatively movable slide block parts, at least one of the parts comprising an oblique surface. The parts of the block are pre-tensioned or biased to move in a direction so that the total width of the slide block will vary and enlarge to fill a gap between inner and outer telescopic jib sections. In a telescopic crane jib-slide block arrangement incorporating such a slide block, the slide block is disposed on an inner telescopic jib section and presents a sliding surface to an adjacent outer telescopic part.

The invention relates to a telescopic crane jib slide block as well as a telescopic crane jib slide block arrangement. In particular, it relates to a self-adjusting slide block, i.e. a slide block which is capable of adapting its width to prevailing circumstances and requirements within its arrangement in or on the telescopic jib, to enable optimum fulfilment of its tasks.

The term “slide block arrangement” used in this context refers to parts of the slide block itself as well as those parts of the telescopic jib or the jib parts which co-operate with the slide block in order to guarantee its function.

The purpose of slide blocks in telescopic jibs is to permit the telescopic action of the telescopic parts relative to one another with the lowest possible friction losses, thereby causing minimum wear on the telescopic parts themselves. As a rule, they are simply inserted between the telescopic parts and are usually affixed to one telescopic part, either the outer one or the inner one, so that the other respective telescopic part is able to run on the slide surface of the slide block.

The disadvantage of such conventional solutions resides in the fact that they permit exact adjustments but only with great difficulty and a large degree of complexity and do so only in a defined locked position, requiring subsequent adjustments (e.g. in the event of wear), and without specific subsequent adjustments or in the event of incorrect adjustment they can lead to an inaccurate fit.

Due to the use of high tensile materials for the manufacture of telescopic jibs and because of the associated reduction in the sheet thicknesses used for the jib, deformations occur in these jibs to a significantly higher degree during operation. Such deformations are to be anticipated due to
(a) backlash in the slide block
(b) bending in the sheeting due to localized transmissions of load (effects of the membrane)
(c) higher wear at the cross-sectional parts
   and can make operation of the crane more difficult, for which reason it is necessary to limit to a minimum all the deformations which occur for the reasons outlined above. Fitting inaccuracies and the design of the slide blocks have a particularly significant influence on (a) and (b) in this respect.

Accordingly, it is desirable to provide a telescopic jib slide block and a telescopic jib slide block arrangement, which offers a fit of optimum accuracy for any telescopic position in order to limit jib deformations to a minimum.

In an embodiment of the present invention, the telescopic jib slide block has at least two co-operating slide block parts, which are mutually pre-tensioned and can be mutually displaced on an oblique surface so that the total width of the slide blocks varies depending on the position of the slide block parts relative to one another. The specific advantage of splitting the slide block into at least two parts in this manner resides in the fact that it enables different widths of the entire slide bock to be set without the need for further measures.

The slide block parts, which may be characterized as wedges with their incline, are preferably designed so that the pre-tensioning effect runs in the height direction along a steep oblique surface, whilst the load to be accommodated (transmission of external force) makes contact with a flat incline in the width direction (essentially transversely to the pre-tensioning). Due to the fact that the force is split between the oblique surfaces, the two individual parts can be mutually displaced with a relatively low amount of force (induced by the pre-tensioning), as a result of which the slide block is adapted to the complementary slide surface. By selecting the individual materials on the basis of their friction properties relative to one another and the complementary effect of pre-tensioning, it is possible, by opting for a sufficiently flat incline, to prevent the individual parts from shifting due to a force in the width direction (effect of external force).

In this width direction, the slide block can therefore be designed to be self-inhibiting. Accordingly, the slide block is able to adjust itself but is not able to shift in response to the external force and can, therefore, transmit the load completely.

Due to the fact that a low displacement force is needed in the pre-tensioning direction, the mutual pre-tensioning of the individual parts can be suppressed during the telescoping action with only a low counter-force.

The air gap which occurs as a result between the slide or bearing surfaces eliminates friction between the sliding parts, so that the telescoping action can be achieved with relatively little cylinder force. Likewise, any variations which occur (i.e., long or short ripples) in the telescoping sections do not affect the slide blocks, which means that any jamming of the telescopic parts on the slide blocks can be ruled out.

The pre-tensioning is preferably suppressed by means of a locking unit (integrated in the telescoping cylinder, for example) which is preferably coupled with the jib lock mechanism in an appropriate way.

This mechanical coupling system ensures that the air gap between the slide or bearing surfaces occurs during the actual telescoping procedure only.

A high-quality width adjustment is advantageously effected automatically. Thus, there is no need for maintenance personnel to be involved in the adjustment. Subsequent adjustment work, such as readjusting the slide blocks for example, is not necessary, which makes for a major saving on time. Automatic readjustments are also made as a means of compensating for wear on the slide blocks.

In one embodiment, the slide block proposed by the invention is designed so that an oblique surface is created by means of the wedge-shaped design of at least one of the slide block parts. It is also possible for both slide block parts to be designed with at least some wedge-shaped portions in order to create the oblique surface.

In a preferred embodiment, the slide block of the invention has a thrust wedge and a sliding part, whereby the positioning of the thrust wedge relative to the sliding part enables a slide surface of the sliding part to be displaced. Accordingly, the sliding part is the part which incorporates the slide surface on which a telescopic part slides during the telescoping procedure.

A telescopic jib slide block arrangement of the invention may have a slide block, of the type used in several of the embodiments described above, or one of a type that will he described in more detail below. The slide block may be disposed on an inner telescopic part, in particular on the base region of an inner telescopic part, in which case an outer telescopic part is able to slide with respect to it. The converse arrangement is also possible, wherein the slide block is disposed in an outer telescoping part.

In the detailed description below, there are frequent references to the way the slide block proposed by the invention is disposed in the base region of a telescopic part. This should not be construed as limiting as it may also be disposed in the telescopic part (jib section) at other appropriate points along its length.

The thrust wedge of the slide block is advantageously secured to the inner telescopic part by means of a pre-tensioning device, in which case the position of the thrust wedge relative to the displaceably disposed sliding part and, hence, also the position of the sliding part, is set by means of the pre-tensioning device. The pre-tensioning device may be a spring-tensioning unit. In a particular embodiment the pre-tensioning device may be a compression spring tensioning unit, which has a fixing means at one end which is affixed to the inner telescopic part and a compression element at the other end, which applies a compression force to the thrust wedge.

The thrust wedge and the sliding part may be disposed in a recess in the inner telescopic part so that they can be displaced and coupled in displacement, specifically so that the movement of the thrust wedge in a first direction causes a movement of the sliding part in a second direction essentially transverse thereto, and vice versa. This can be configured so that the direction of movement of the thrust wedge is essentially what is a vertical direction relative to the cross-section of the inner telescopic part and essentially at a tangent to the telescopic part contour, and the direction of movement of the sliding part is an essentially horizontal direction and extends essentially radially outwards from the inner telescopic part. The latter “horizontal” direction is the direction which bridges the gap between the innertelescopic part and the outertelescopic part.

If the thrust wedge and the sliding part are disposed in a recess in the inner telescopic part, as noted, the slide surface of the sliding part projects outwards through an orifice in the external wall of the telescopic part. The size or extent of the projection will depend on the relative position of the thrust wedge and slide block.

In one variant, the pre-tensioning can be set by means of an adjusting mechanism on the pre-tensioning device, in particular by means of an adjusting mechanism for the length of a compression spring. In addition, the pre-tensioning can be selected or adjusted, depending on the size of the gap between the telescopic parts, so that the slide block with its slide surface always bridges the gap between the inner and outer telescopic parts due to the force of the thrust wedge.

The present invention may also include a slide block arrangement wherein the thrust wedge has a contact point or engagement point for a lock bolt of a telescoping cylinder. In that event, the contact poinvengagement point and/or the bolt are designed so that the bolt is bolted into the inner telescopic part and pushes the thrust wedge against the pre-tensioning device, thereby relieving the sliding part of at least some of the force acting on it due to the thrust wedge. As a result of this feature, a lighter mutual telescoping action of the telescopic parts is possible because the friction forces are reduced. The contact poinvengagement point of the thrust wedges and/or the bolt may have chamfered or angled co-operating surfaces in such an embodiment, which cause the thrust wedges to be displaced during bolting in. Other options are also be possible as a means of lifting the thrust wedge or moving it back slightly from the sliding part with the lock bolt, for example levering or cable tensioning mechanisms between the bolt and thrust wedge or thrust wedge and steel bolting unit.

The invention will be described in greater detail below with reference to preferred embodiments. All of the characterising features described herein may be used individually and in any combination. Of the appended drawings:

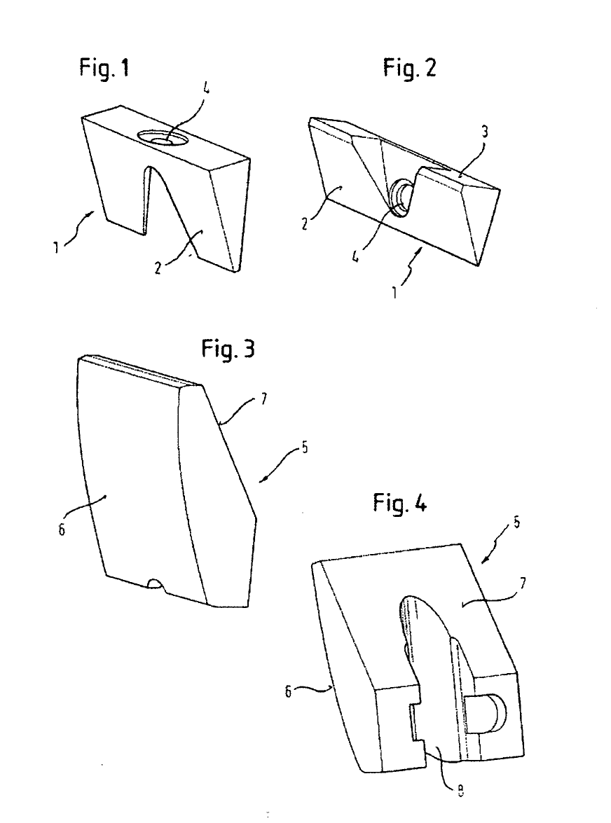

FIGS. 1 and 2 show various views of a thrust wedge of a slide block according to the invention;

FIGS. 3 and 4 show various views of a sliding part of the slide block according to the invention;

FIG. 5 shows a slide block according to the invention built into a telescopic part-base piece;

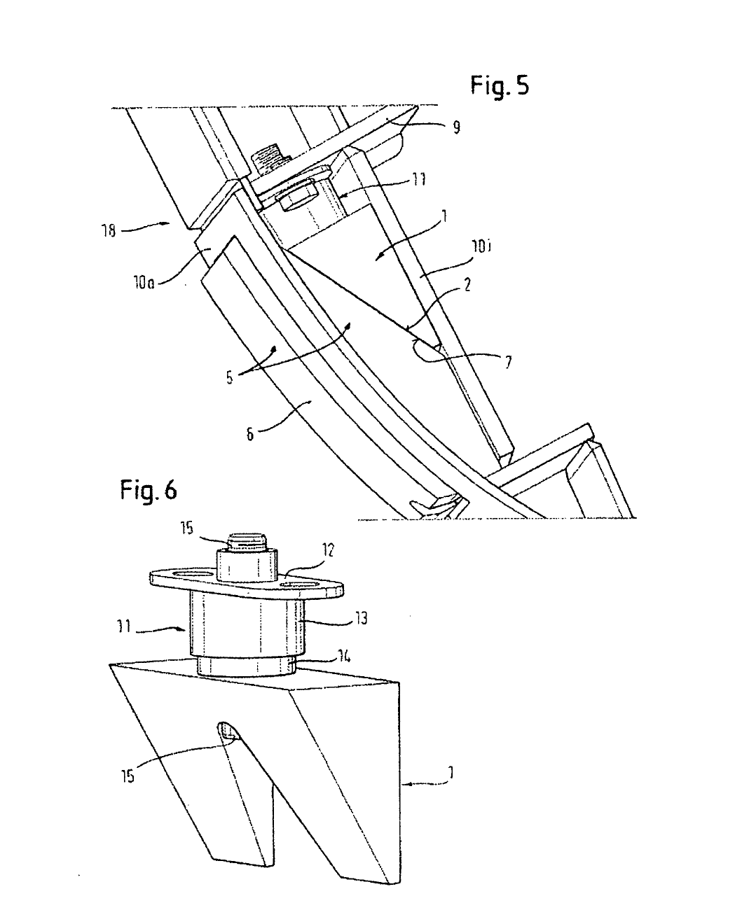

FIG. 6 shows a thrust wedge with a pretensioning device;

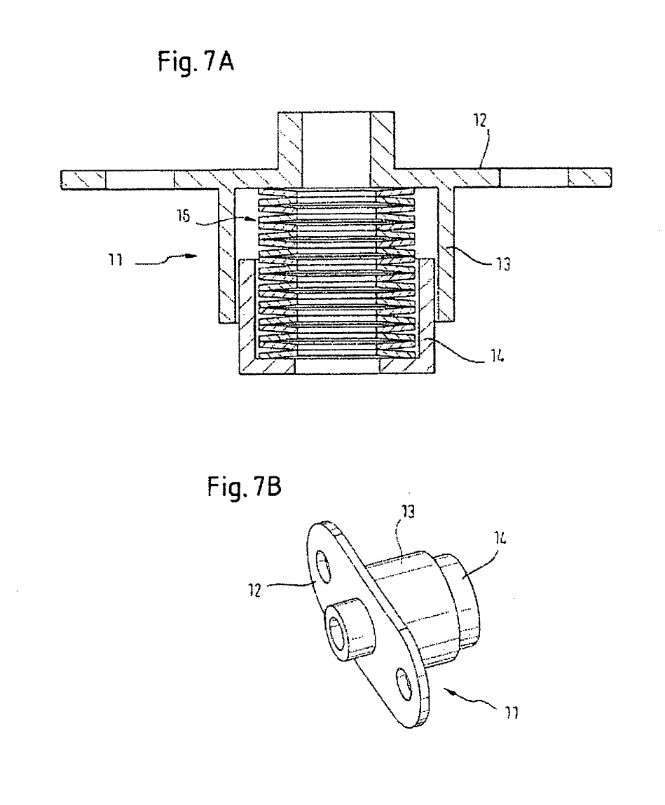

FIGS. 7A and 7B show the pre-tensioning device from FIG. 6 in detail;

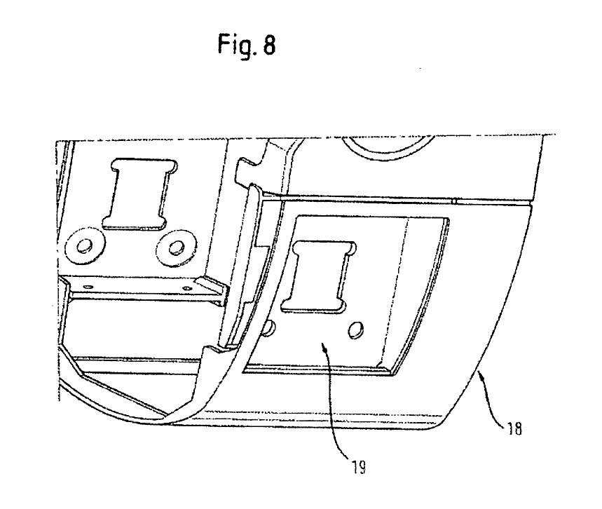

FIG. 8 is a view of a telescopic part-base piece with a recess for a slide block according to the invention;

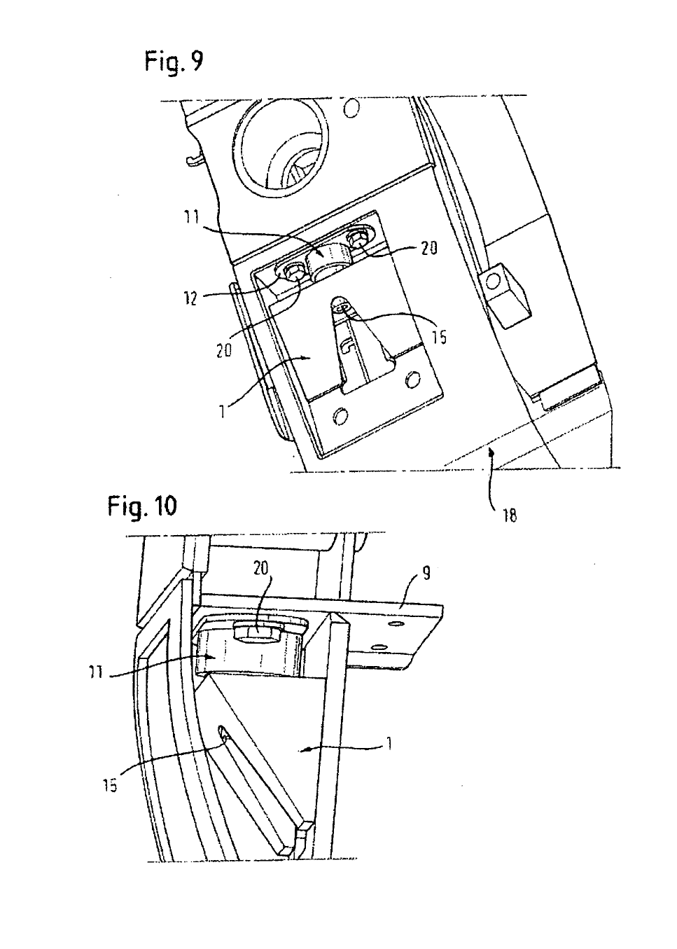

FIGS. 9 and 10 show views of the base piece with built-in thrust wedge;

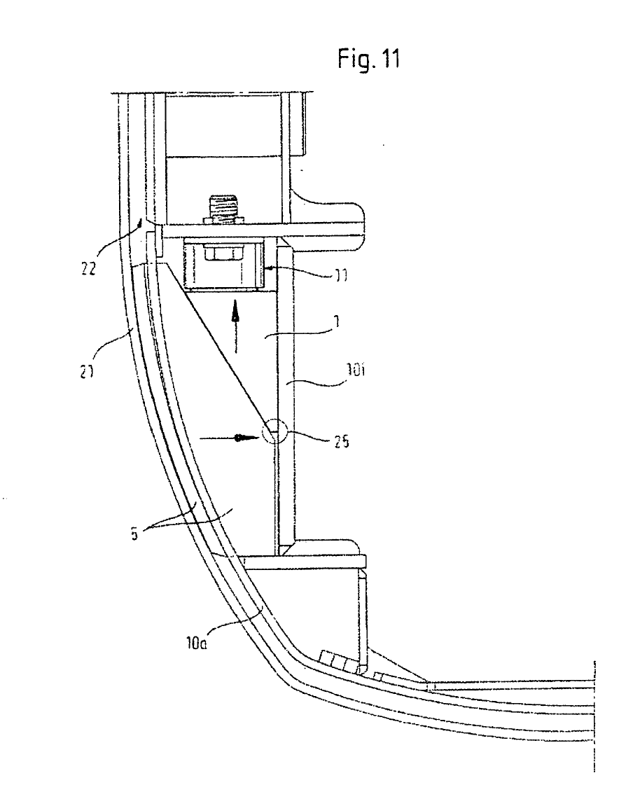

FIGS. 11 to 13 show different operating situations of the slide block arrangement with different gap sizes between the telescopic parts;

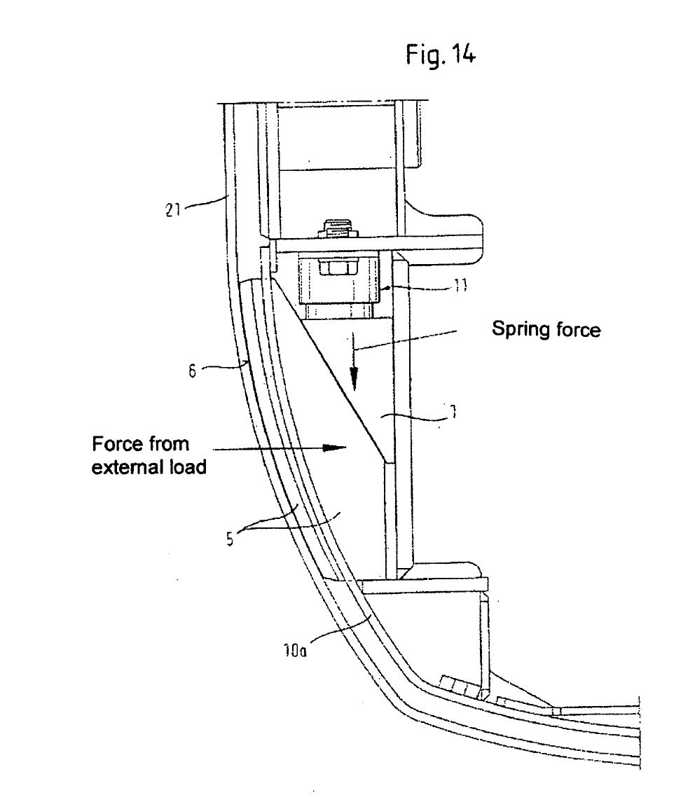

FIG. 14 is a diagram of the slide block arrangement on a larger scale with the relevant acting forces indicated; and

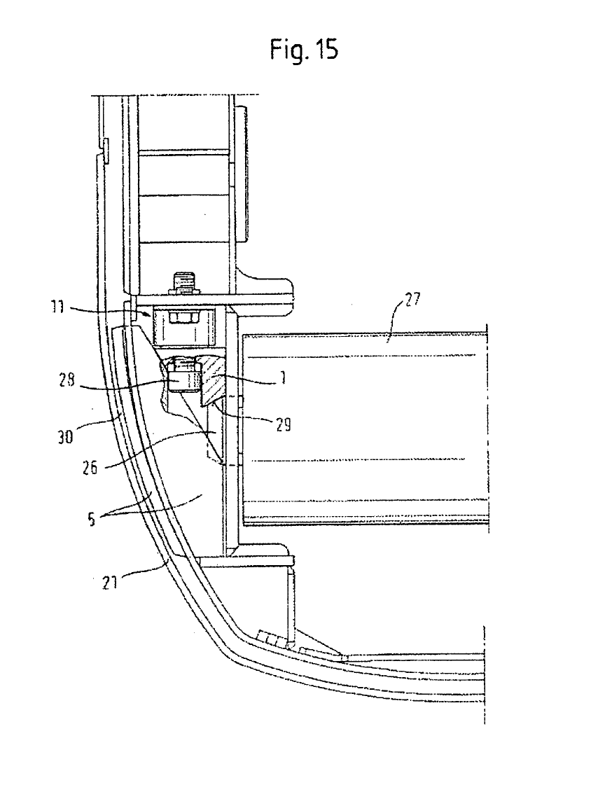

FIG. 15 shows an embodiment of a slide block arrangement according to the invention with a lock bolt-release.

FIGS. 1 to 4 are a detailed illustrations and a perspective diagram of the individual parts of one embodiment of a slide block according to the invention. The slide block consists of two parts, namely the thrust wedge 1 (FIGS. 1 and 2) and the sliding part 5 (FIGS. 3 and 4). The thrust wedge 1 has a wedge surface 2 as well as a bearing surface 3. It also has a fixing device 4 which, in this example, is provided in the form of a recessed orifice for engaging a pre-tensioning device, which will be described in more detail below.

The sliding part 5 illustrated in FIGS. 3 and 4 constitutes the complementary piece to the thrust wedge 1 and has the slide surface 6 on its external face and a wedge surface 7 on its internal face. Wedge surface 7 comes into contact and co-operates with the wedge surface 2 of the thrust wedge when the parts are in the assembled state. Sliding part 5 also has a recess 8. A part of the pre-tensioning device is accommodated in the recess 8 as well as in the recess of the thrust wedge (see FIGS. 5, 6, 9 and 10).

The slide block may be seen in the assembled state in FIG. 5. The slide block comprising the thrust wedge 1 and the sliding block 5 lies essentially between frame webs 10a (outer) and 10i (inner) of a jib section 18, and underneath web 9. A part of the sliding part 5 extends through an orifice in the frame part 10a and does so in such a way that the slide surface 6 projects out to the exterior of the jib section. The outer telescopic jib part, which is not illustrated in FIG. 5, slides on the sliding surface 6.

The pre-tensioning device 11, which is provided in the form of a compression spring tensioning device, may be seen in FIGS. 5 and 6 as well as in FIGS. 7A and 7B. It comprises a fixing element 12 and an outer cylindrical cup 13 and an inner spring cup 14. The spring pack 16 (FIG. 7A) ensures that the thrust wedge 1 is pushed downwards by the inner spring cup 14 and, because of the two wedge surfaces of the mutually abutting thrust wedge 1 and sliding part 5, pre-tensions sliding part 5 outwards.

As may be seen from FIG. 5, the thrust wedge is guided on one side (surface 3 in FIG. 1) on the web 10i. The wedge surface 2 of the thrust wedge 1 lies on the surface 7 of the sliding part 5. An essentially vertical displacement of the thrust wedge 1 causes a horizontal displacement (outwards) of the sliding part 5 due to the inclination of the wedge surfaces and, in this respect, particular attention should be paid to the design and inclination of this oblique wedge surface, as well as to the choice of material, particularly in respect of the coefficient of friction to obtain proper functioning of the device. The operating situations which occur as a result will be explained in more detail below.

The pre-tensioning device, which will also be referred to as a whole by the term spring cup 11, is secured to the web 9. The inner spring cup 14 presses onto the bordered recess 4 of wedge 1, as illustrated in FIG. 1, and does so from above with the force of the spring packet 16. An orifice in the recess 4 enables an adjusting screw 15 to be passed through. Adjusting screw 15 is more clearly illustrated in FIG. 9.

FIGS. 9 and 10 show views of a telescopic jib part or base piece, as does FIG. 8. FIG. 8 illustrates a portion of the base piece denoted by reference number 18 and the recess (pocket) for the slide block denoted by reference number 19. FIGS. 9 and 10 illustrate more clearly how the spring cup 11 with its mounting element 12 is secured by two screws 20 and how the adjusting screw 15 projects into the recess of the thrust wedge 1. The adjusting screw 15 has a hexagon socket, by means of which the initial length of the spring packet and hence the initial positioning force can be set. The position illustrated in FIG. 10 corresponds more or less to a half-tensioned initial setting.

A description will now be given of various operating states with different gap sizes between the base piece or the inner telescopic part, measured from the outer web 10a, and the mast of an outer telescopic part, the latter being denoted by reference number 21, with reference to FIGS. 11, 12 and 13.

FIG. 11 illustrates a situation with a minimal gap size between the telescopic parts, indicated by arrow 22. The outer jib or mast 21 in this instance is, thus, disposed very close to the web 10a. This may be the case due to a specific operating setting or due to existing tolerances, for example if the base piece was produced with maximum positive tolerances and the mast piece 21 with maximum negative tolerances. In this state, the spring packet of the spring cup 1 1 is fully tensioned because the mast piece 21 forces the slide block 5 very far inwards (arrow), causing the thrust wedge 1 to be forced along the web 10i and a long way upwards on the mutually abutting wedge surfaces 2 and 7. In specific situations, the spring packet in the spring cup 11 is biased forwards to block length. At the point denoted by reference number 25 in FIG. 11, it may be seen how far the thrust wedge 1 has been pushed upwards.

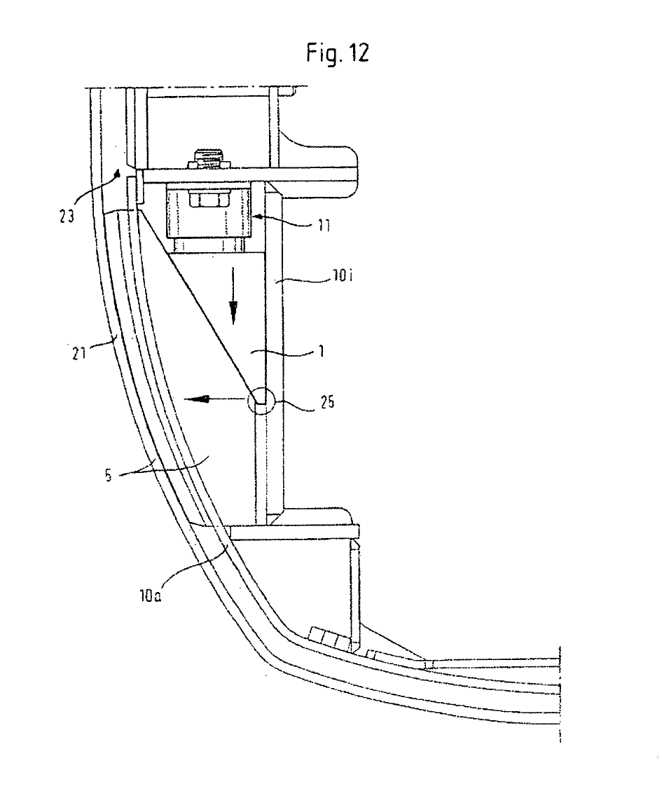

A state with a normal or typical gap size, in other words either in a corresponding operating situation or with zero tolerance in the mast piece 21 and base piece, results in the state illustrated in FIG. 12. The spring packet in the spring cup 11 is partly pre-tensioned. In other words the spring cup is extended to a portion of the maximum stroke or extension of the springs, and pushes the thrust wedge 1 downwards (arrow), which in turn pushes the slide block 5 outwards until it abuts with the outer telescopic mast 21. In this illustration the highlighted point 25 shows that the thrust wedge 1 has reached what may be characterized as a middle position.

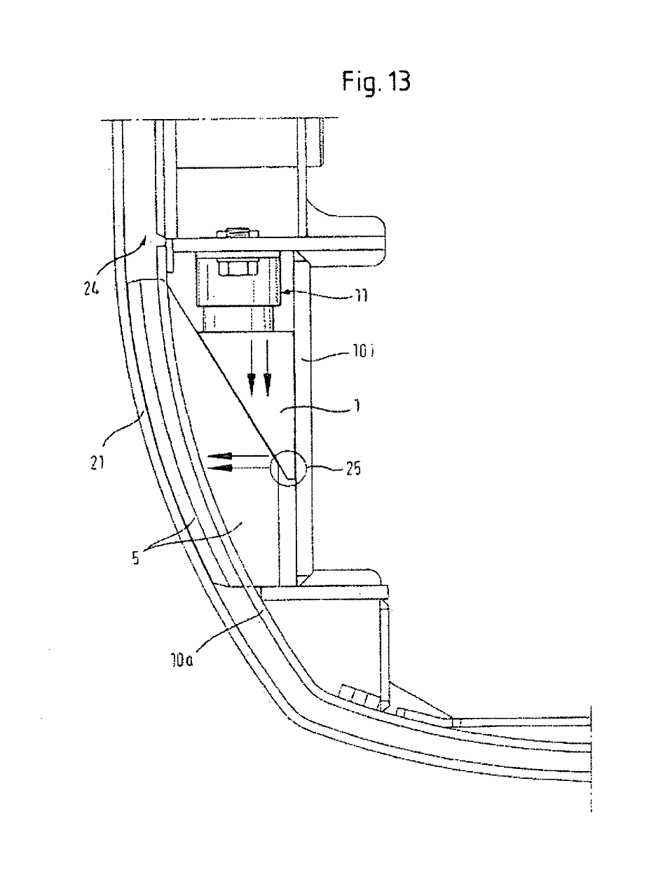

FIG. 13 illustrates a state in which a larger gap width exists between the base piece and the next largest mast piece 21. This can also occur in specific operating situations or if the base piece was manufactured with maximum negative tolerances and the mast piece with maximum positive tolerances. As may be seen, the spring packet in the spring cup 11 has extended a larger or maximum stroke and the thrust wedge 1 has been pushed very far down. This is particularly apparent from the highlighted point 25. Accordingly, the thrust wedge 1 pushes the sliding part 5 very far outwards (left) via the oblique wedge surfaces 2 and 7, until the gap between the base piece (web 10a) and the next largest mast piece 21 is bridged.

Thus, in different operating states and in all possible tolerance configurations, the outer mast 21 abuts with the slide surface of the sliding part 5 as a result of the spring force of the spring cup 11 acting on the wedge part 1 as shown in FIG. 14. Any shifting of the sliding piece due to the action of external force, as also shown in FIG. 14, is prevented by the design of the slide block of the invention, specifically the angle of the wedge faces 2 And 7 which effectively prevent such movement due to external load forces.

Another feature of the invention is illustrated in FIG. 15. The slide block arrangement illustrated in FIG. 15 corresponds to that described above. An apparatus comprising an extensible jib or mast typically includes a device (such as a piston-cylinder device) for extending and retracting the jib sections. An interlocking mechanism typically forms a part of the extension-retraction device for selectively engaging each jib section to extend or retract each in turn. It is common for such an interlocking mechanism to include a pin that selectively engages a jib section at the desired moment for that purpose.

FIG. 15 illustrates an apparatus that comprises extension-retraction device that includes, i.e., a telescoping cylinder 27. Associated with the head of device 27 is a pin or lock bolt 26 which projects outwardly therefrom to engage element 10i so as to connect to the jib section to move it axially. As pin or bolt 26 engages element 10i of the jib section, it also engages the thrust wedge 1. The bolt has a chamfer 29 which, a it engages the thrust wedge 1, causes the wedge to be lifted slightly upwards, moving it away from adjusting screw 28. To effect this movement it is of practical advantage for the surface of the thrust wedge 1 that engages the pin or bolt 29 to be provided with a shape complementary to the engaging surface of the lock bolt, as illustrated.

Due to the fact that the wedge 1 is lifted by the lock bolt as it engages the jib section, the sliding part 5 is relieved of some of the force applied to it by the thrust wedge 1 and is no longer pre-tensioned against the outer mast piece 21. As a result of the relieved force against the sliding part 5, there may appear an air gap 30 between part 5 and the outer mast piece 21 as seen in FIG. 15. The friction between the block 5 and mast 21 is relieved and the telescoping cylinder device 27, therefore, need apply only a relatively low force to effect the telescoping action. The system as a whole is, therefore, independent of the tolerances in the outer telescope part. Additionally, there is no need or a reduced need to lubricate the slide blocks.

1. A slide block for a telescopic crane jib, comprising at least two slide block parts displaceable relative to each other, at least a first slide block part comprising an oblique surface contacting the second slide block part, and a pre-tensioner exerting a force on the first slide block part to effect relative movement of said slide block parts, whereby the total dimension of the slide block in at least one direction varies depending on the relative position of the slide block parts.

2. A slide block as in claim 1, wherein the pre-tensioner exerts a force on the first slide block part to move said first slide block part relative to the second slide block part along said oblique surface.

3. A slide block as in claim 1, wherein said oblique surface is created by a wedge-shaped design of at the first slide block part.

4. A slide block as in claim 1, wherein each of said at least two slide block parts has an oblique surface, said oblique surfaces of said slide block parts facing each other.

5. A telescopic crane jib comprising relatively extendable and retractable jib sections, and a slide block as in claim 1, wherein the slide block is disposed on an inner telescopic jib section and provides a sliding surface against which an outer telescopic jib section slides during relative movement of said jib sections.

6. A telescopic crane jib and slide block arrangement as in claim 5, wherein said first slide block part comprises a thrust wedge and is secured to the inner telescopic part by means of said pre-tensioner, the position of the thrust wedge relative to the inner jib section being variable as a result of force applied to the thrust wedge by said pre-tensioner, and the second sliding block part is displaceable relative to the inner jib section as a result of movement of said first sliding block part, whereby the position of the second sliding block part varied by the pre-tensioner.

7. A telescopic crane jib and slide block arrangement as claimed in claim 6, wherein the pre-tensioner is secured at one end to the inner telescopic part, said pre-tensioner comprising a spring which exerts a force on the thrust wedge.

8. A telescopic crane jib and slide block as in claim 6, wherein the thrust wedge and the second sliding block part are disposed in a recess in the inner telescopic jib section.

9. A slide bock as in claim 1, wherein movement of said first sliding block part is in a first direction, which movement in said first direction causes movement of the second sliding block part in a second direction substantially transverse to said first direction.

10. A telescopic crane jib and slide block arrangement as in claim 6, wherein movement of said thrust wedge is in a first direction, which movement in said first direction causes movement of the second sliding block part in a second direction substantially transverse to said first direction.

11. A telescopic crane jib and slide block arrangement as in claim 6, wherein movement of the second sliding block part is along a direction that is substantially radial with respect to the axial cross section of the inner telescopic part.

12. A telescopic crane jib and slide block arrangement as in claim 6, wherein the thrust wedge and the second sliding block part are disposed in a recess in the inner telescopic jib section and the second sliding block part projects outwardly through an opening in the external wall of the inner telescopic jib section, the extent of such projection depending on the positional relationship between the thrust wedge and the second slide block part.

13. A slide block arrangement as in claim 1, further comprising an adjustor for said pre-tensioner.

14. A telescopic jib and slide block arrangement as in claim 6, wherein the pre-tensioner is provides a force to the thrust wedge to move the thrust wedge and the second slide block part to positions wherein the slide block bridges the gap between the inner and outer telescopic parts.

15. A telescopic jib and slide block arrangement as in claim 6, further comprising an extension/retraction device for extending and retracting the telescopic jib sections, said extension/retraction device comprising a pin for engaging each jib section to be extended or retracted, wherein the pin engages the thrust wedge associated with a jib section upon engaging the respective jib section, such engagement with said thrust wedge displacing the thrust wedge against the force of the pre-tensioner, thereby relieving pressure between the second sliding block part and the adjacent outer jib section.

16. A telescopic jib and slide block arrangement as in claim 15, wherein the pin and the thrust wedge have chamfered co-operating contact surfaces which cause the thrust wedge to be displaced when the pin engages the thrust wedge.

17. A telescopic jib and slide block arrangement as in claim 6, further comprising an adjustor for said pre-tensioner.
